(19) United States
(12) Patent Application Publication
(10) Pub. No.: US 2013/0090942 A1
(43) Pub. Date: Apr. 11, 2013

(54) SYTEM AND METHOD FOR PREVENTING HEALTHCARE FRAUD

(71) Applicants: Robert N. Robinson, Penfield, NY (US); George M. Vigelette, Walworth, NY (US)

(72) Inventors: Robert N. Robinson, Penfield, NY (US); George M. Vigelette, Walworth, NY (US)

(73) Assignee: SAFE-LINK, LLC, Penfield, NY (US)

(21) Appl. No.: 13/444,470

(22) Filed: Apr. 11, 2012

Related U.S. Application Data
(63) Continuation-in-part of application No. 13/270,783, filed on Oct. 11, 2011.

(51) Int. Cl. G06Q 50/22

(52) U.S. Cl. 705/2

(57) ABSTRACT

The present invention provides a method for reducing healthcare fraud potentially committed by a healthcare worker and possibly the client as well. The method includes the steps of capturing and storing a first biometric signature received of the healthcare worker. A first geographical location is provided based on the client location. During a visit to the client location, a second biometric signature of the healthcare worker is captured. A second geographical location is then captured via a device from which the second biometric signature was captured and received. This is followed by the step of comparing the first biometric signature to the second biometric signature to determine the eligibility of the healthcare worker in billing insurance provider for services purported to have been rendered.

### PRIORITY CLAIM AND RELATED APPLICATIONS

This continuation-in-part application claims the benefit of priority from non-provisional application U.S. Ser. No. 13/270,783 filed Oct. 11, 2011. Said application is incorporated by reference in its entirety.

### BACKGROUND OF THE INVENTION

1. The Field of the Invention The present invention is directed generally to a healthcare monitoring system. More specifically, the present invention is directed to a mobile biometric home healthcare monitoring system to improve healthcare and prevent healthcare billing fraud.

2. Background Art

Fraud is a moving target as criminals shift to new and more sophisticated schemes as opportunities arise. Although a fraud may be corrected after it has been committed, the focus must be placed on prevention because the cost to recover losses may significantly outweigh the amount lost to the fraud itself. In many cases, once an improper payment has made due to fraud, only a small portion is ever recovered. The nation's ever-growing Medicaid budget echoes calls for the U.S. government to do more to combat fraud and incorporate greater technological approaches to keep up with sophisticated scams run by providers and recipients who take advantage of the current Medicaid program. The sheer size of the Medicaid program is one of the largest challenges that the nation faces. In New York state alone, there is a projected budget that exceeds $52.5 billion in fiscal year 2010-11 and more than one fifth of the state's population is enrolled in the Medicaid program. The size of this budget presents many opportunities for deception and dishonesty. While it is very difficult to determine an exact amount of Medicaid dollars lost to fraud, the estimates range from 3% to 10%. Based on this estimate, New York state taxpayers are losing between $1.5 and $5 billion each year and the American taxpayers are losing hundreds of billions of dollars nationwide annually due to fraud.

Criminals have developed numerous inventive ways to steal taxpayers' money. As the Medicaid system has grown in size and complexity, preserving the integrity of the program has become more challenging. One of the most common forms of Medicaid Fraud is false claim schemes, such as billing for services not provided. This very problem is the focus of the present invention.

Prior to the present invention, a telephonic delivery monitoring and verification program has been attempted to address Medicaid fraud. In November 2010, Sandata Technologies launched a fixed location tracking device in hopes of tying verification activities to locations. Both these systems help deter and prevent fraud, but are flawed since they are both pin based systems making it easy for anyone to enter the health provider's code.

Given the foregoing, what are needed are systems and methods for discouraging and preventing healthcare-related insurance fraud in ways superior to prior proposed solutions.

### SUMMARY OF THE INVENTION

The present invention meets the above-identified needs by providing systems and methods for deterring and preventing, thereby reducing healthcare-related billing fraud.

In one aspect, the present invention provides a method for reducing healthcare fraud potentially committed by a healthcare worker and possibly the client the healthcare worker is assigned to care for as well. The method includes the steps of capturing and storing, in a central repository, a first biometric signature received of the healthcare worker. A first geographical location is provided based on the client location (or address). Then, during a visit to the client location, a second biometric signature of the healthcare worker is captured and received in the central repository. A second geographical location is then captured and stored in the central repository via a device from which the second biometric signature was captured and received. In the present embodiment, the data including second biometric signature and the geographical signature are captured using a proxy mobile device and transmitted to a cell phone via short range wireless communication. The data is then transmitted to a web server operably connected to the cell phone. The web server then saves the data to the central repository. This is followed by the step of retrieving the first biometric signature and the first geographical location of the first client location from the central repository. Then, the first biometric signature is compared to the second biometric signature to produce a first result and the first geographical location is compared to the second geographical location to produce a second result to verify the eligibility of the healthcare worker in billing insurance provider for services purported to have been rendered. This allows an encounter record to be created in the central repository, wherein the encounter record comprises a first flag which indicates the results of the comparisons made.

In one embodiment, the short range wireless communication comprises Bluetooth.

Accordingly, it is a primary object of the present invention to provide a healthcare fraud prevention system and method which utilizes a proxy mobile device that is a small form factor device and one that is capable of operable connection to a ubiquitous cell phone.

It is another object of the present invention to provide a system and method that combines the use of biometric signature and location authentication to determine the presence of a healthcare worker at a client location during the period which the healthcare worker bills.

It is another object of the present invention to provide a healthcare fraud prevention system and method which utilizes at least one biometric signature matching to aid in reducing the ease with which the system can be tampered with.

It is another object of the present invention to provide a healthcare fraud prevention system and method which is not cumbersome to use, tamperproof and durable such that continual use of such a system is encouraged.

It is yet a further object of the present invention to provide a healthcare fraud prevention system and method that holds healthcare workers assigned to provide care to clients, accountable and increases the quality of care to a client by ensuring that the healthcare worker assigned to the client is indeed present at the client's location.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram of an exemplary personnel identity validation and eligibility verification system according to various aspects of the invention.

FIG. 1A is a flowchart depicting one embodiment of the present identity validation means for preventing healthcare fraud.

FIG. 1B is a flowchart depicting an additional validation means for preventing healthcare fraud.

FIG. 1C is a flowchart depicting yet an additional identity validation means for preventing healthcare fraud.

FIG. 1D is a flowchart depicting yet another validation means for preventing healthcare fraud for use while a client is away from his residence.

FIG. 2 is a functional block diagram of an exemplary computer system useful for implementing the handheld validation of the present invention.

FIG. 3 is a block diagram depicting encrypted communication between a handheld validation device and a central system.

FIG. 4 is a block diagram of an exemplary software system useful for implementing the present invention.

FIG. 5 is a diagram depicting the communication means between a proxy mobile device and web servers.

FIG. 6 is a functional block diagram of the embodiment of FIG. 5 useful for enabling communication between the hardware platform and one or more web servers.

FIG. 7 is a functional block diagram depicting an exemplary computer system useful for implementing a proxy mobile device of the present invention.

FIG. 8 is a sequence diagram depicting one embodiment of the communication means depicted in FIG. 5.

FIG. 9 is a sequence diagram depicting another embodiment of the communication means depicted in FIG. 5.

### PARTS LIST

2—central system
4—central repository
6—internal network
8—private branch exchange PBX
10—internet
12—client's phone line
14—agency computer
16—cellular network
18—GPS satellite
20—communication between GPS satellite and device
22—communication between cellular network and device
24—communication between internet and device
26—communication between client's phone and device
28—client's home
30—handheld validation device
31—simplified handheld validation device or proxy mobile device
32—accelerometer
34—cryptography services
36—point-to-point communication between client's phone and PBX
38—case sensor
40—touch screen display
42—LED light module
44—device sensors module
46—device input module
48—device input/output i/o ports
50—hardware platform
52—power supply module
54—web servers
56—communication between handheld validation device and web servers
58—GPS sensor
60—GPS antenna
62—biometric input device
64—communication module
66—storage device
68—USB
70—audio module
72—Bluetooth module of device 30 or 31
74—firewall
76—ARM processor
78—NAND flash
80—flash boot ROM
82—supporting integrated circuits
84—battery charging and monitoring device
86—battery
88—AC/DC converter from external power
90—auxiliary input/output ports
92—agency login interface
94—web portal
96—web services
98—authentication and verification services
100—audio communication services
102—software/firmware automatic update services
104—time tracking services
106—device monitoring and status services
108—application software
110—agency dashboard
112—time tracking system
114—reporting system
116—step of capturing and storing first biometric signature of healthcare worker in central repository during enrollment period and providing first geographical location
118—step of capturing and receiving second biometric signature of healthcare worker and second geographical location in central repository during visit to client's home
120—step of retrieving first biometric signature from central repository
122—step of comparing first biometric signature to second biometric signature to produce first result and comparing first geographical location to second geographical location to produce second result
124—step of creating encounter record in central repository and a first flag to indicate first and second results
126—step of capturing and storing first voice signature of healthcare worker in central repository during enrollment period
128—step of capturing and receiving second voice signature of healthcare worker in central repository
130—step of retrieving first voice signature from central repository
132—step of comparing first voice signature to second voice signature to produce third result
134—step of adding second flag to indicate third result to encounter record
136—step of activating a request for a response from healthcare worker
138—step of starting a first timer for a response time period within which the response is expected to be received
140—step of receiving and transmitting response from healthcare worker to central repository
142—step of comparing response to request to produce fourth result
144—step of adding third flag to indicate fourth result to encounter record
146—step of capturing and storing third biometric signature of client in central repository during enrollment period
148—step of activating request for fourth biometric signature from client during visit of healthcare worker
150—step of starting a second timer for a response time period within which the fourth biometric signature is expected to be received
152—step of capturing and storing fourth biometric signature and third geographical location of client in central repository
154—step of capturing and storing fifth biometric signature and fourth geographical location of healthcare worker in central repository
156—step of retrieving third biometric signature from central repository
158—step of comparing fourth biometric signature to third biometric signature to produce fourth result, comparing fifth biometric signature to first biometric signature to produce fifth result and comparing fourth geographical location to third geographical location to produce sixth result
160—step of adding fourth flag to indicate fourth result, adding fifth flag to indicate fifth result and adding sixth flag to indicate sixth result
162—communication between cell phone and web servers
164—communication between simplified handheld validation device and cell phone
166—cell phone
168—application of cell phone
170—Bluetooth of cell phone
172—step of sending encrypted minutia data of identification number (ID) via short range radio device
174—step of sending encrypted minutia data of ID via internet
176—step of comparing encrypted minutia data with base data
178—step of sending validation result
180—step of displaying validation result
182—step of requesting base data of ID
184—step of sending base data from web server to cell phone
186—step of comparing encrypted minutia data to base data
188—step of displaying validation result
190—step of requesting data of ID from central repository
192—step of sending base data from central repository to web server
194—step of sending validation result of ID from cell phone to web server
196—step of sending validation result of ID from web server to central repository
198—step of saving validation result of ID to central repository

### PARTICULAR ADVANTAGES OF THE INVENTION

Short range wireless communication is used between a proxy mobile device and a ubiquitous cell phone which receives encrypted minutia data from users and transmits it to at least one web server. A short range wireless communicator is used such that the user may not fraudulently report his or her true location as the cell phone used to receive and transmit data from the proxy mobile device via the short range wireless communicator is required to be placed within about 10 ft from the proxy mobile device.

The present proxy mobile device has a small form factor of about 1.75″ inches×about 2.75″ inches×about 0.5 inches. It can be conveniently attached to a key chain, cell phone and another personal device frequently brought along with a user for convenience.

The present fraud prevention system utilizes a combination of biometric signature and location authentication to verify the identity of a healthcare worker and that the healthcare worker is indeed present at a client's location when he or she bills for services purported to have been rendered at the client's location. The present system prevents payout of unauthenticated bills, therefore eliminating the efforts and expenses involved in making corrections on overpaid bills. Biometric signature authentication is more tamper resistant than a code protection system as anyone may enter a code using a keypad in response to a request to such code.

Another advantage lies in the ease of use. A healthcare worker or client is typically requested to provide a biometric signature for authentication. The location is automatically captured when a biometric signature is captured and both are sent to a central repository where an agency can access to monitor the healthcare worker and/or the client. The ease of use of additional authentication means also fall within the realm of abilities or the healthcare worker or the client. A healthcare worker or the client the healthcare worker cares for is requested via one of various means to respond to the request. Such request can be tailored to the ability of the client. A blind client, for instance, can be presented with an audio request instead of a visual request. On the other hand, a deaf client can be presented with a visual request instead.

Yet another advantage lies in the ability to authenticate the identity of the healthcare worker and/or the client when they are away from the client's place of residence, i.e., in exception cases. Under some Medicaid arrangements, clients are allowed to work away from home, carry out daily chores or spend time at recreational facilities while being supervised by a healthcare worker. As such, it is impractical to verify the absolute location of the healthcare worker and/or the client. The present invention provides a means to verify that the healthcare worker is in close proximity to the client after the healthcare worker requests for ensuing time period to be treated as an exception.

Yet another advantage lies in the ability to provide redundant means for verifying the presence of a healthcare worker at a client's location. If biometric signature authentication fails, a secondary means for authenticating the presence of the healthcare worker can be used. The second means include voice signature detection and the verification of a response to a request sent to the healthcare worker. Although the redundant means are used primarily in case the primary means for authentication, i.e., via biometric signature authentication, fails, the secondary means may also be used in cooperation with biometric signature authentication especially if suspicious behaviors of the healthcare worker have been previously detected.

Applicants discovered that device failure has been commonly cited as a reason for a healthcare worker to avoid using a verification tool assigned. The tampering of a device with the intent to either disable or replace one or more functions of the device is commonly done by the employee or healthcare worker to which the device is assigned such that the malfunction of the device can be used as an excuse to not perform a job the healthcare worker is assigned. Applicants discovered various means for detecting such an attempt which include detecting the power level of the device, electronically detecting case integrity of the device and repeated failure of biometric signature capturing effort.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

The present invention is directed to systems and methods for deterring and preventing healthcare insurance fraud. Home healthcare is provided to individuals who need long term or short term care due to a medical condition such as reduced mental capability brought on by a trauma or disease. Such individuals or clients typically require special care which their family members are incapable of providing. As such, these individuals or their representatives seek help from Medicaid to provide home healthcare or supervision at a job. In one aspect, Medicaid delegates such responsibility to private healthcare agencies or hereinafter agencies to manage the healthcare needs of clients. An agency typically hires healthcare workers to care for the needs of clients. Such agency is in turn compensated by a Medicaid program based on the number of hours reported by the agency. The agency in turn compensates the healthcare workers based on number of hours worked. There exists opportunities for fraud in time reporting for compensation as it is not feasible for an agency to audit each home healthcare account due to distances or needs for privacy. Typical fraud committed includes but not limited to false reporting of time worked and unauthorized substitution of healthcare workers. The most common scenario for false reporting of time involves reporting of time period in which services were not actually provided to the clients. The most common scenario for substitution of healthcare workers occurs when the assigned healthcare worker uses an unauthorized or less qualified individual to provide care to clients. The applicants propose a solution which, if implemented properly, can aid in deterring or preventing such healthcare fraud involving home healthcare situations where their frequent supervision is not feasible or effective with existing systems. In some situations, clients cooperate with healthcare workers to defraud Medicaid in hopes that a portion of the ill gotten compensation from Medicaid be passed on to the clients. In one aspect, the present invention provides a means for validating the identity of an individual purported to be a healthcare worker and/or the identity of the individual purported to be a client the healthcare worker is assigned to provide care. In another aspect, the location at which care is provided is also verified. The present invention further provides a means to validate a healthcare worker and/or the client while care is provided at a location away from the client's home, an example of which occurs when the healthcare worker takes the client for a doctor's visit or a rehabilitation facility or even a recreational facility. The present invention is now described in more detail herein in terms of these contexts.

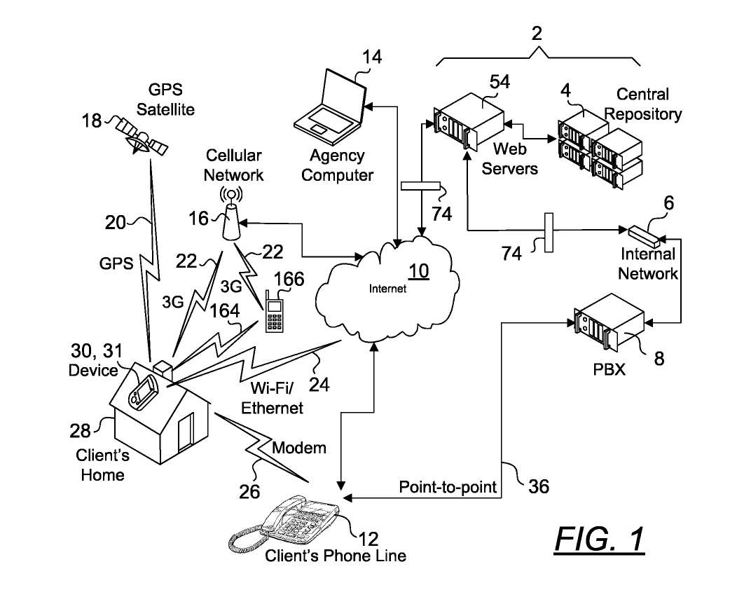

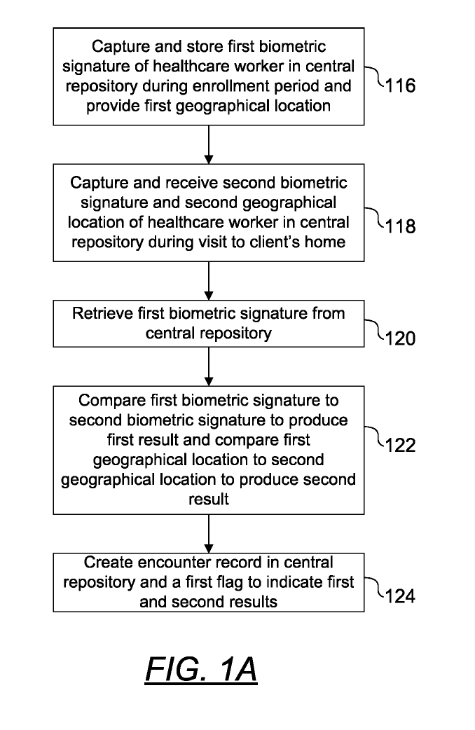

FIG. 1 is a diagram of an exemplary personnel identity validation and eligibility verification system according to various aspects of the invention. FIG. 1A is a flowchart depicting one embodiment of the present identity validation means for preventing healthcare fraud. FIG. 2 is a functional block diagram of an exemplary computer system useful for implementing the handheld validation of the present invention. A healthcare agency is engaged by a Medicaid insurance program to provide healthcare services to a client at the client's home 28. In such an aspect, the following process may occur:
(a) Step 116—A healthcare worker is hired by the agency and a first biometric signature is captured of the healthcare worker at the agency in a web application executing at least partially in a web server 54 via a biometric scanner operably connected to an agency computer 14 and transmitted over a network (e.g., the internet 10) to a central repository 4, wherein the first biometric signature is associated with other identity information (such as driver's license or passport) provided by the healthcare worker which has been validated. The captured first biometric signature is stored in a central repository 4. Upon determining the client that the healthcare worker is assigned to supervise, a first geographical location is determined by the agency based on the residence address 28 of the client. The first geographical location can be a set of latitude and longitude information which is an estimate of the client's residence to within about 50 ft. The first geographical location is stored in the central repository 4 and associated with the first biometric signature. There is now established a link between the first biometric signature, the first geographical location and the client. In one preferred embodiment, the first biometric signature is a fingerprint scan. In another embodiment, the first biometric signature is an iris scan;
(b) Step 118—During a visit of the healthcare worker to the client location 28, a second biometric signature is captured and received of the healthcare worker in a web application executing at least partially in a web server 54 via a biometric input device 62 in the central repository 4. During a login process to start billable time, a second geographical location is captured, stored in the central repository 4 and associated with a handheld validation device 30 from which the second biometric signature was captured, received and transmitted over the internet 10. In one embodiment, the second geographical location is captured using a Global Positioning System GPS sensor 58 which communicates via a GPS protocol through a GPS antenna 60 with GPS satellites 18. Such communication 20 includes direct satellite communication or any combinations of direct satellite communication and relays. In another embodiment, the second geographical location is provided by means of cellular and/or Wi-Fi triangulation. A biometric input device 62 is provided to capture the second biometric signature which in turn is processed in a hardware platform 50. The device 30 is preferably small in size and capable of fitting comfortably in one's hand;
(c) Step 120—The first biometric signature and the first geographical location of the first client location are retrieved from the central repository 4;
(d) Step 122—The first biometric signature is compared to the second biometric signature to produce a first result and the first geographical location is compared to the second geographical location to produce a second result; and
(e) Step 124—An encounter record is created in the central repository which includes a first flag to indicating the results of the comparisons made in step (d).

The agency can then use the encounter record to determine whether the healthcare worker is eligible in collecting a payment for the time period in which services is purported to have been rendered. If the first flag indicates a match for both the biometric signature and geographical location comparisons, the payment claim for the time period after step (d) is allowed. If the first flag indicates a mismatch for at least one of the comparisons, the payment claim for the time period after step (d) is denied. A timestamp is stored alongside each instance of the data storing activity above based on a local reference time of the central repository 4. In case of a dispute or audit of the payment, the stored data in the central repository may be retrieved and studied. In one embodiment, during a logout process at the end of a shift, the healthcare worker again initiates the aforementioned steps (b)-(e). If the first flag indicates a mismatch, the payment claim for the time period from the last time when the first flag indicated a match to the present time is refused.

In one embodiment of the present invention, an additional identity validation means is provided to either serve as an additional or replacement validation means to the biometric signature means previously disclosed. In any case, a first and second geographical locations are still collected for verifying that the healthcare worker is present in the client's home while voice recognition is performed. Referring again to FIGS. 1, 1B and 2, in one embodiment, the present invention further comprises the following process:
(a) Step 126—A first voice signature of the healthcare worker is received in the central repository 4. At about the time the first biometric signature was obtained, the agency can require that the first voice signature to be taken;
(b) Step 128—A second voice signature of the healthcare worker is captured by the agency when it puts in a call to the device 30 via a cellular communication network 16 in its communication with the healthcare worker. In one embodiment, the call contains a recorded voice request that prompts a voice response in the form of a phrase. In another embodiment, this voice request is manually made by the agency. The request is broadcast in the audio output device 70 while the first voice signature is received in the audio input device 70 and stored in the central repository 4. In order to have higher success and reduce false positives, the expected voice response is typically a simple word or phrase;
(c) Step 130—The first voice signature is retrieved from the central repository 4.
(d) Step 132—The first voice signature is compared to the second voice signature to produce a third result; and
(e) Step 134—A second flag is created and set to indicate the third result and added to the encounter record.

The agency can then use the encounter record to determine whether the healthcare worker is eligible in collecting a payment for the time period in which services is purported to have been rendered. If the second flag indicates a match, the payment claim for the time period after step (d) is allowed. If the first flag indicates a mismatch for at least one of the comparisons, the payment claim for the time period after step (d) is refused.

In another embodiment, an additional validation means is provided to either serve as an additional or short term replacement validation means to the biometric signature means previously disclosed. In any case, first and second geographical locations also are still collected for verifying that the healthcare worker is present in the client's home while this validation means is performed. Referring again to FIGS. 1, 1C and 2, in one embodiment, the present invention further comprises the following process:
(a) Step 136—A request is activated to solicit a response from the healthcare worker. The request is again recorded in the central repository 4. The request can be a text instruction displayed on the touch screen display 40, a flashing LED 42, an audible tone provided through the audio output device 70 or a vibrating device;
(b) Step 138—A first timer is started for a response time period within which the response is expected to be received;
(c) Step 140—A response is received and transmitted from the healthcare worker to the central repository 4. The expected response can be a push of a button to acknowledge the receipt of the request. The expected response can also be the collection of a biometric signature from the healthcare worker;
(d) Step 142—The response is compared to the request to produce a fourth result; and
(e) Step 144—A third flag that indicates the fourth result is added to the encounter record.

If the first timer expires before a response is received or if the received response does not match the request, the healthcare worker becomes ineligible to receive payment associated with the time period after step (d) of the visit.

In addition to the methods disclosed elsewhere in the disclosure, various provisions have been made in the present invention to prevent tampering of the device 30. The motivation behind device tampering typically is to either disable or replace one or more functions of the device such that the failure of the device can be cited as an excuse to not perform one's job. The healthcare worker assigned a device 30 is required to ensure the device 30 is properly powered such that the device 30 is functional when it is expected to be used. The healthcare worker is required to place the device 30 in a charging configuration while not in use. For example, the device 30 can either receive wall power source to power an onboard battery charging device 84 through an AC/DC converter 88 or the battery charging device can be alternatively disposed outside of the device 30. In one aspect, a fully charged battery 86 typically can power the device 30 for about 2 days of continuous use without recharging. In the event that the battery 86 level is determined to be low by the battery monitoring device 84, a visual alert is provided on the touch screen display 40 to inform the healthcare worker of the low battery level status such that appropriate action can be taken (i.e., to place the device 30 in a condition to be recharged). The onset of a low power level or “battery low” condition is stored in the central repository 4. When the low power level condition no longer exists, the transition to “battery normal” power level is again stored in the central repository 4. The integrity of the present device 30 is ensured by electronically detecting case integrity of the device 30. The present device 30 comes in the form of a generally rectangular box with one accessible face which is normally protected with a lid, sealing the access and mechanically secured to the box. A case sensor 38 is mounted in a configuration such that when the lid is separated from the box, a “case open” condition is stored in the central repository. Further, the agency is capable of detecting repeated failure of biometric signature capturing effort. A repeated failure is defined as 3 attempts to validate biometric signature within 5 minutes. A “repeated failure” condition is stored in the central repository 4. Yet further, an agency subscribing to the present system can take advantage of the capability of the present system to detect multiple sets of billable hours, submitted to multiple agencies simultaneously, from one healthcare worker for a time period. In other words, if a healthcare worker attempts to submit more than one set of billable hours for a time period to multiple agencies, the present system which maintains all billable hours and biometric signatures from multiple agencies will flag this condition.

In situations during a visit of the healthcare worker where the healthcare worker and the client need to leave the client's location, an exception condition has to be logged. An exception condition is communicated via device 30 and stored in the central repository 4. In one embodiment, a button (software or hardware) is made available on the device 30 to enable entry or exit of the exception condition via the press of the button. Upon communicating this condition to the agency, the agency can then respond with a different validation strategy. Instead of tying the healthcare worker to the client's location, the validation strategy now switches to tying the location of the healthcare worker to the location of the client. In this exception condition, the client and the healthcare worker have moved from the client's home 28 to a second client location. In such an aspect, the following process as depicted in FIG. 1D may occur:
(a) Step 146—a third biometric signature of the client is captured and stored in a central repository 4 during a second enrollment period;
(b) Step 148—a request for a fourth biometric signature from the client is activated during the visit of the healthcare worker;
(c) Step 150—a second timer for a response time period within which the fourth biometric signature is expected to be received is started;
(d) Step 152—a fourth biometric signature received of the client and a third geographical location associated with the device from which the fourth biometric signature was captured and received were captured and stored in the central repository 4;
(e) Step 154—a fifth biometric signature received of the healthcare worker and a fourth geographical location associated with the device from which the fourth biometric signature was captured and received were captured and stored in the central repository 4;
(f) Step 156—the third biometric signature is retrieved from the central repository 4;
(g) Step 158—the fourth biometric signature is compared to the third biometric signature to produce a fourth result, the fifth biometric signature is compared to the first biometric signature to produce a fifth result, the fourth geographical location is compared to the third geographical location to produce a sixth result; and
(h) Step 160—a fourth flag to indicate the fourth result, a fifth flag to indicate the fifth result and a sixth flag to indicate the sixth result are added.

If at least one of the fourth, fifth and sixth flags indicates a mismatch, the healthcare worker becomes ineligible to receive payment associated with a time period after step (g) of the visit.

As will be appreciated by those skilled in the relevant art(s) after reading the description herein, in an aspect, the web application described above executes on one or more web servers 54 (as shown in FIG. 1) providing one or more websites which send out web pages in response to Hypertext Transfer Protocol (HTTP) or Hypertext Transfer Protocol Secured (HTTPS) requests from remote browsers. Thus, such web servers 54 are able to provide a graphical user interface (GUI) to users of the device 30 and the agency computer 14 or other devices utilizing the web application of the web servers 54 in the form of web pages. These web pages are sent to device 30, agency computer 14, user's desktop, laptop, mobile device, PDA or like terminal devices and result in the GUI screens being displayed.

As will also be appreciated by those skilled in the relevant art(s) after reading the description herein, in an aspect, the traffic 56 between the device 30 and a computer (e.g., web servers 54 and agency computer 14) or all other devices operably connected to the present invention is routed through one of the networks (e.g., cellular 22, Wi-Fi or Ethernet 24, modem 26, point-to-point 36) and the internet 10. In one embodiment, a public Branch exchange (PBX) 8 connects a client's phone line 12 via point-to-point 36 connection to an internal network 6 of the agency. The internal network 6 is operably connected to the web servers 54 which can be remotely located or locally located with the internal network 6. The internal network typically resides in a physical location of the agency. In one embodiment, one or more agency computers 14 may be connected directly to the internal network 6 or directly to the internet 10. The central repository 4 is operably connected to the web servers 54.

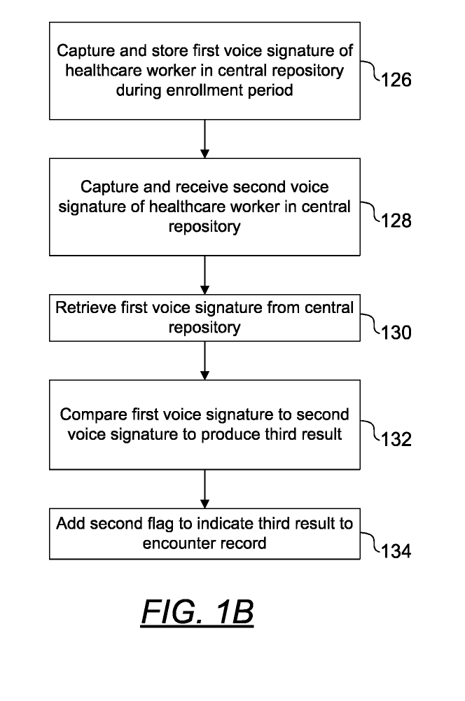

FIG. 3 is a block diagram depicting encrypted communication between a handheld validation device 30 or proxy mobile device 31 and a central system 2 for ensuring that all data transferred between the devices 30, 31 and central system 2 is performed in a secured manner. In one aspect, the traffic described earlier is routed through one or more firewalls 74 configured such that only authorized connections can gain access to the central system 2. The purpose of the firewall 74 is to provide security and restrict unauthorized access to the central system 2 and the healthcare worker and client data stored and processed therein.

As will also be appreciated by those skilled in the relevant art(s) after reading the description herein, in an aspect, an application service provider (i.e., an entity providing the infrastructure for one or more healthcare agencies, insurers and/or recipients) with multiple locations at one or more corresponding URLs) may allow access, on a paid subscriber/membership, and/or pay-per-use basis, to the tools (i.e., web application) the present invention provides for performing healthcare worker and/or client identity validation and eligibility verification.

The present invention (i.e., the process steps described above with reference to FIGS. 1-3, and the systems and methods for preventing healthcare related insurance fraud described above, or any part(s) or function(s) thereof) may be implemented using hardware, software or a combination thereof and may be implemented in one or more computer systems or other processing systems. However, the manipulations performed by the present invention were often referred to in terms, such as “capturing,” “storing,” or “receiving,” which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers, smart phones, cell phones, tablets, pads and similar devices.

Referring back to FIG. 2, the device 30 can include a hardware platform 50 which is functionally connected to a device input module 46, a device sensors module 44, a light emitting diode LED 42, a touch screen display 40, a power supply module 52 and a device input/output module 48. The hardware platform 50 can include one or more processors, such as Acorn RISC Machine (ARM) processor 76. The processor 76 is connected to a flash boot read only memory (ROM) 80 which allows boot related computer programs or other instructions to be loaded into the device 30, a NAND flash 78 which allows computer programs or other instructions to be loaded into the device 30 and other supporting integrated circuits (ICs) 82. The device input/out module 48 can include a communication module 64 which services 3^{rd} generation (3G) or newer mobile telecommunication standards such as 4^{th} generation (4G), ethernet and wireless fidelity (Wi-Fi) communication with respective networks, a storage device 66, a universal serial bus (USB) 68, a Bluetooth 72 and an audio input/output device 70. The device input module 46 can include a GPS antenna 60 and a biometric input device 62. Although not depicted, another personal identification device may be incorporated in addition to the biometric input device 62. The device sensors module 44 can include an accelerometer 32 for providing motion data such that impact (or tampering attempt) exerted to device 30 can be determined, a case sensor 38 for determining tampering attempts, and a GPS sensor 58 for providing geographical locations. The power supply module 52 can include a battery charging and monitoring device 84 for charging and detecting the battery level of a lithium-ion battery 86 and an AC/DC converter 88 to receive external power.

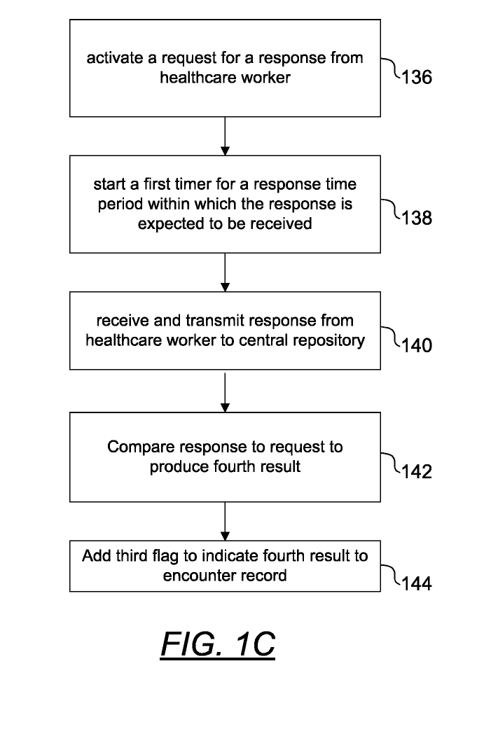

FIG. 4 is a block diagram of an exemplary software system useful for implementing the present invention. The exemplary software system comprises an application software 108, web portal 94 and web services 96 which in one embodiment, are loaded to and executable in at least one of the web servers 54. Referring to both FIGS. 2 and 4, the application software 108 can include an agency dashboard 110 where the agency can visit and see the status of all the agency's employees. At any time, an agency supervisor can send a verification signal to the client's home to verify if a healthcare worker that is logged in is present. A verification request can be programmed to automatically and randomly be sent to device 30 to ensure that the healthcare worker is actually at the client's residence 28. The verification notification is received at the device 30 residing in the client's home and displays on the touch screen display 40, asking the healthcare worker to authenticate via a biometric scanner operably connected to the biometric input device 62. In addition, an audible tone can be emitted via the audio output device 70 and the LED 42 is flashed to alert the healthcare worker that a request has been received at the device 30. In one embodiment, when the verification request is received, the healthcare worker has 15 minutes to verify that he is at the client's residence or billable time stops and a notification is sent to the agency so that it can follow up with the healthcare worker and/or the client.

The application software 108 also includes a time tracking system 112, a reporting system 114 for aggregating information pertinent to time periods of service and validation and verification status and an agency login interface 92 useful to facilitate login of an agency.

The web services 96 can include authentication and verification services 98, software or firmware automatic update services 102, device monitoring and status services 106, audio communication services 100, time tracking services 104 and cryptography services 34.

The time tracking system 112 provides a means to schedule a healthcare worker. A healthcare worker is typically allowed a certain number of billable hours in a time period, e.g., 70 normal billable hours, 30 overtime billable hours or 100 total billable hours in a week. The time tracking system 112 can be configured to receive the number of allowed billable hours per time period and the number of hours actually billed. A warning signal can be generated to alert the agency if a healthcare worker has exceeded or is approaching the number of allowed billable hours. Alternatively or in addition, an alarm can be set to alert the agency as the pace at which worked hours is accumulated exceeds a pre-determined rate, e.g., if a total allowed number of billable hours planned for a week has been approached within the first two days of the week, a condition is raised to the agency, healthcare worker and client to indicate a potential problem.

The time tracking services 104 serve as a time collector where events such as collections of biometric signatures and their corresponding geographical location data are time stamped such that a healthcare worker's reported time periods of service can be examined or verified. Referring to FIGS. 2 and 4, device 30 may be configured to receive a request via touch screen display 40 for the number of billable hours left to be worked based on the number of billable hours which have already been worked or accumulated by the time tracking services 104 of the web services 96 and the total allowed billable hours.

The authentication and verification services 98 provide a means by which biometric signatures are verified, a means by which the proximity of the client to his responsible healthcare worker, a means to determine whether a healthcare worker is at a designated location during a billable period, etc. In the case of the healthcare worker is present but not able to verify his presence, the agency can resolve this issue by examining the time tracking services 104 and manually repair time recording. In case a healthcare worker is forced to log out, a signal is sent to flash the LED 42 on device 30. A notification is sent to the touch screen display 40 indicating that the healthcare worker account was logged out. The healthcare worker can re-log in and billable time will begin again and the agency will have the opportunity to modify time tracking for that healthcare worker. This situation may be most prevalent during overnight client visits where there may not be anyone at the agency to handle an alert immediately.

The cryptography services 34 provide a means by which encrypted communications between device 30, agency computer 14 and the web servers 54. The central repository 4 is operably connected to both the application software 108 and the web services 96 such that information pertinent to the time periods of healthcare workers, clients and their personal identification information can be stored and retrieved. The web portal 94 provides an interface where the agency can access via the agency's computer 14 and the internet 10 to take advantage of any of the services available in the application software 108 and the web services 96.

The device monitoring and status services 106 monitor and respond to any devices operably connected to the hardware platform 50, e.g., the biometric input device 62, accelerometer 32, case sensor 38, GPS sensor 58 and sensors or devices operably connected to the auxiliary input/output ports 90.

The device monitoring and status services 106 can also monitor distances traveled to ensure reimbursement of mileage is reported correctly by the healthcare worker. Geographical location information may be retrieved from the central repository 4 such that distances between locations can be derived and compared against the distances submitted to an agency for reimbursement.

Referring back to FIGS. 1, 2 and 4, various other device sensors may also be monitored, e.g., a blood pressure and heart rate monitoring device may be operably connected via an auxiliary input/output port 90 to the hardware platform 50. Device 30 may be configured to transmit blood pressure and/or heart rate periodically to the central repository 4. An alert may be displayed on the agency dashboard 110 if a blood pressure or heart rate reading has exceeded a pre-determined threshold. The monitoring of a device can include comparing an input reading of a device against a pre-determined threshold, whereupon if the input reading of the device exceeds the pre-determined threshold, a response if initiated. The response can include displaying an alert on the agency dashboard 110, flashing the LED 42, automatically dialing a pre-determined cellular phone number, etc. Pre-determined threshold can be a geographical location, heart rate or blood pressure reading indicating health problems, distance between client and responsible healthcare worker, etc.

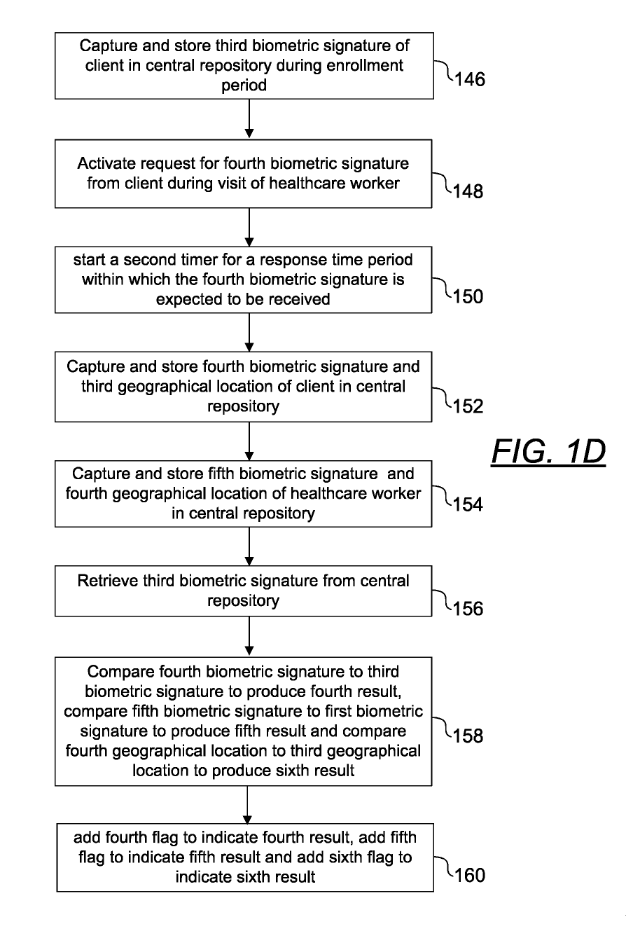

FIG. 5 is a diagram depicting an alternate communication means between a simplified handheld validation device or proxy mobile device 31 and at least one web server 54. Referring back to FIGS. 1 and 5, in one embodiment, a simplified handheld validation device 31 is used instead of handheld validation device 30. Device 31 communicates via short range radio waves with a cell phone 166 as depicted in communication 164. An exemplary short range radio device is a Bluetooth equipped device capable of operating at Bluetooth v2.1+Enhanced Data Rate (EDR). The use of a short range wireless communicator for the proxy mobile device-cell phone communication is novel in that it prevents the healthcare worker from reporting his/her location at a distance from his/her designated location (or client's location). In another embodiment, Radio Frequency Identification (RFID) technology may be utilized in the transfer of data between device 31 and the cell phone. In yet another embodiment, RFID technology including Near Field Communication (NFC) may be used to pair device 31 with a cell phone for increased fraud protection. In this instance, an NFC tag is disposed in device 31 and an NFC receiver is configured to detect the presence of the NFC tag prior to allowing communication between the cell phone 166 and device 31. As compared to device 30, communication and computational capabilities of device 31 are essentially removed from device 30 and shifted to the cell phone 166 or a web server 54 as will be explained elsewhere herein. Various hardware and their corresponding drivers that are configured for interfacing with a user remain, such as the audio module 70, accelerometer 32, case sensor 34, GPS sensor 58, GPS antenna 60, biometric input device 62, LED 42, USB 68 and the like. In one aspect, device 31 passes along encrypted minutia data including biometric signature and geographical location data received from a user to the cell phone 166 and receives software updates or other critical information in device 31 in return. When the cell phone 166 is used as a two-way proxy, an application running on the cell phone 166 initiates communication 162 via the internet 10 with the web server 54 by passing it biometric signature and geographical location data received via short range radio communication from device 31. The cell phone 166 may receive a software update via the internet 10 from the web server 54 and passes it along via short range wireless communication to device 31. In this instance, steps 120, 122 and 124 of FIG. 1A are executed by an application running in the web server 54. When the results of comparisons between the first and second sets of biometric signature and geographical location become available, they are transmitted to the cell phone 166 for display on the screen of the cell phone 166.

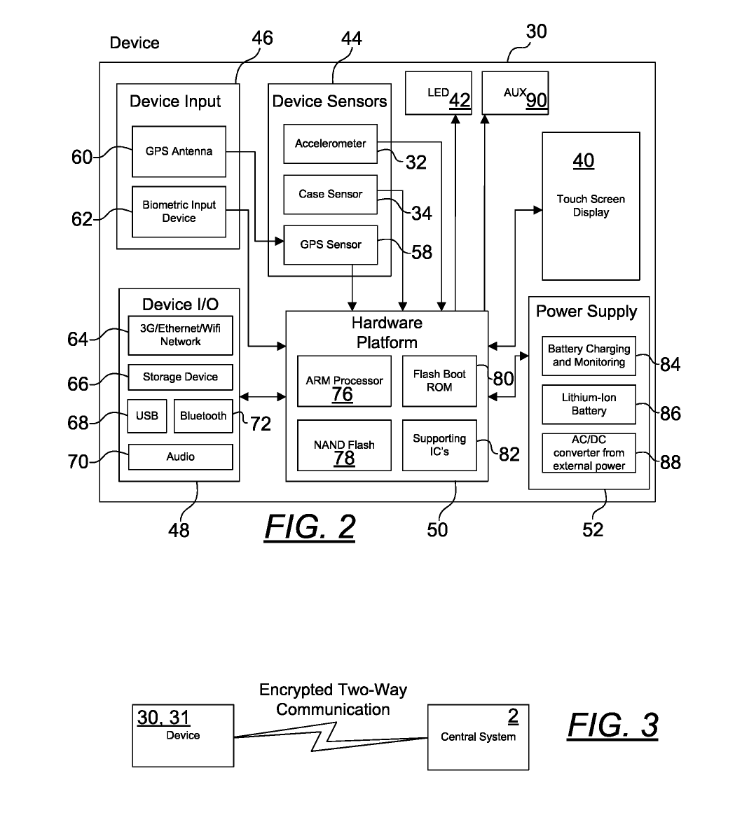

FIG. 6 is a functional block diagram of the embodiment of FIG. 5 useful for enabling communication between the hardware platform and one or more web servers. In contrast to the configuration of FIG. 2, communication module 64 of FIG. 2 which is responsible for 3G or Ethernet or Wi-Fi and the touch screen display 40, have been removed as they are unnecessary in device 31, thereby reducing hardware costs required in such a dedicated device configured for interfacing with the user. Cell phones and cell phone applications have become ubiquitous communication tools. As most users of the present invention are already users of cell phones with Bluetooth capability, the implementation of the present invention is simplified and made more affordable as dedicated device capable of communicating via 3G or new cellular network or Wi-Fi or even wired Ethernet is rendered unnecessary.

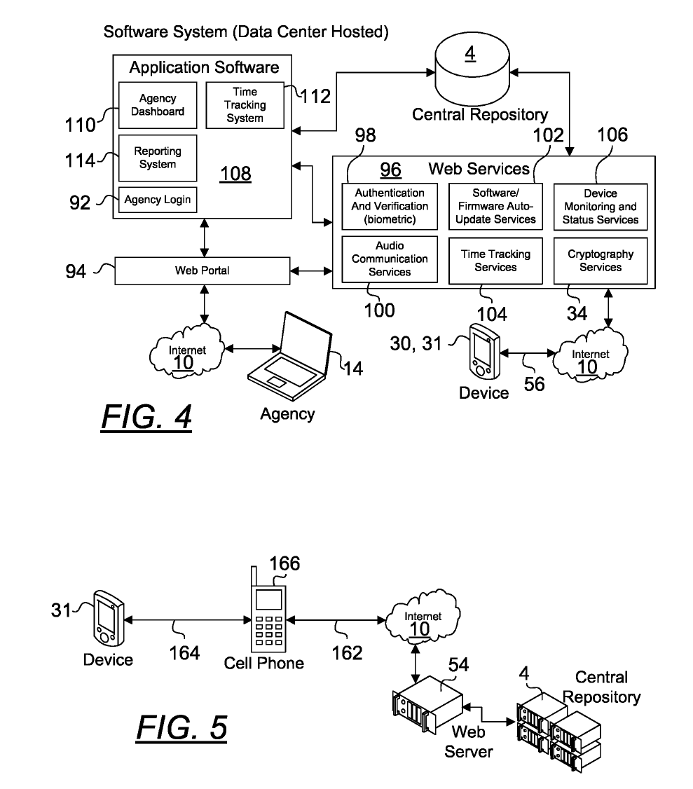

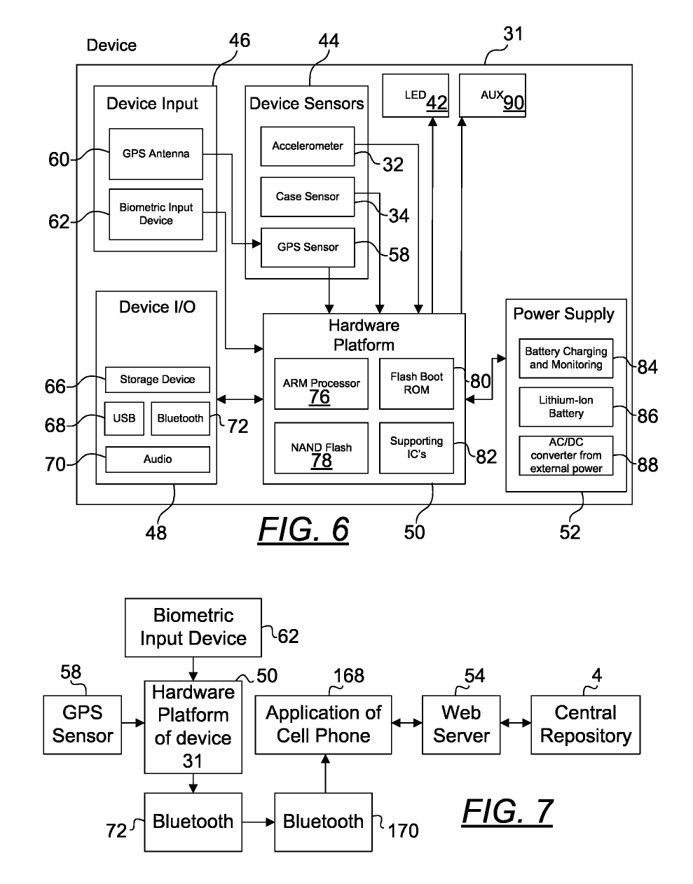

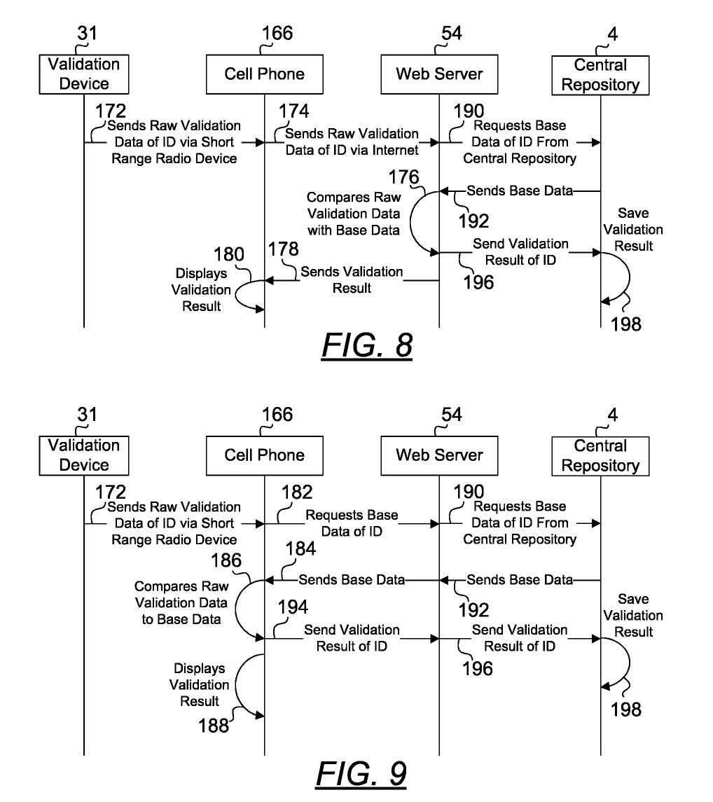

FIG. 7 is a functional block diagram depicting an exemplary computer system useful for implementing the alternate communication means of FIG. 5. FIG. 8 is a sequence diagram depicting one embodiment of the alternate communication means of FIG. 5. FIG. 9 is a sequence diagram depicting another embodiment of the alternate communication means of FIG. 5. In these embodiments, the hardware platform 50 is configured to receive data from a biometric input device 62 and GPS sensor 58 and take advantage of a Bluetooth 72 module to communicate the data to a Bluetooth module 170 of a cell phone. An application 168 suitable for execution in a plurality of cell phone brands, types, models and operating systems, is provided, for instance, iPhone®, Droid®, BlackBerry® and the like. Upon receiving the data via Bluetooth module 170, the application 168 forwards the data via a cellular network or Wi-Fi to a web server 54 operably connected to a central repository 4. The web server 54 either writes data to or retrieves data from the central repository 4.

FIG. 8 depicts a scenario where processing of encrypted minutia data including the second biometric signature and second geographical location occurs in a web server 54. Although this example discusses only biometric signatures and their corresponding geographical location, the use of a proxy mobile device 31 does not represent a reduction in capabilities as compared to device 30. Various hardware and drivers not available on the proxy mobile device 31 may alternatively be provided on the cell phone 166 and its corresponding application configured for interfacing with the proxy mobile device 31. In step 172, the encrypted minutia data captured at device 31 is sent to cell phone 166. The cell phone 166 is configured to send, in step 174, the encrypted minutia data via the internet to the web server 54. Each set of data comprises an identification number (ID) to indicate the source of the data set. The web server 54 retrieves base data including the first biometric signature and the first geographical location corresponding to the ID from a central repository 4 by sending a request 190. In response to the request, the central repository 4 sends a set of base data corresponding to the ID to the web server 54. This is followed by the web server 54 comparing the encrypted minutia data to the base data (step 176). A validation result indicating whether or not a match has been found between the base data and the encrypted minutia data, is then sent via step 178 to the cell phone 166 and subsequently displayed in step 180 on a screen of the cell phone 166. The same result is also sent in 196 to the central repository 4 to be saved in step 198 as part of an encounter record.

FIG. 9 depicts a scenario where processing of the encrypted minutia data occurs in a cell phone 166. In step 172, the encrypted minutia data captured at device 31 is sent to cell phone 166. The cell phone 166 is configured to request a set of base data of ID via the web server 54 in step 182. The web server 54 in turn sends the request in step 190 to the central repository 4. In response to the request, the central repository 4 sends a set of base data corresponding to the ID to the web server 54 as in step 192. The web server 54 in turn sends the set of base data as in step 184 to the cell phone 166. Upon receiving the set of base data, the application of the cell phone 166 then compares the encrypted minutia data to the base data as in step 186. A validation result is then sent back to the web server 54 as in step 194. This validation result is in turn sent back as in step 196 to the central repository 4 to be saved in step 198 as part of an encounter record. The cell phone 166 is also configured to display the validation result on a screen of the cell phone 166.

We claim:

1. A method for reducing healthcare fraud, wherein a healthcare worker is employed by an agency to provide health care to a client at a first client location, said method comprises the steps of:
(a) capturing and storing, in a central repository, a first biometric signature received of said healthcare worker and providing a first geographical location based on said first client location during a first enrollment period;
(b) capturing and receiving, in a proxy mobile device, a second biometric signature of said healthcare worker during a visit of said healthcare worker to said first client location and a second geographical location associated with said proxy mobile device from which said second biometric signature was captured and received;
(c) communicating via a communication means, said second biometric signature and said second geographical location to a web server operably connected to said central repository and storing said second biometric signature and said second geographical location in said central repository;
(d) retrieving said first biometric signature and said first geographical location of said first client location from said central repository;
(e) comparing said first biometric signature to said second biometric signature to produce a first result and comparing said first geographical location to said second geographical location to produce a second result; and
(f) creating an encounter record in said central repository, wherein said encounter record comprises a first flag indicating the results of the comparisons made in step (e),
wherein the eligibility of said healthcare worker to receive payment associated with a time period after step (e) of said visit based on the presence of said healthcare worker at said first client location as determined by said first flag is processed.

2. The method of claim 1, wherein said communication means comprises communicating, via a communication method, said second biometric signature and said second geographical location to a cell phone which in turn communicating said biometric signature and said second geographical location to said web server.

3. The method of claim 2, wherein said communication method is short range wireless communication.

4. The method of claim 3, wherein said short range wireless communication is Bluetooth.

5. The method of claim 1, wherein said first and second biometric signatures are selected from the group consisting of fingerprint scan and iris scan.

6. The method of claim 1, further comprising the steps of:
(a) capturing and storing, in said central repository, a first voice signature received of said healthcare worker during said first enrollment period;
(b) capturing and receiving, in said proxy mobile device, a second voice signature of said healthcare worker during a visit of said healthcare worker to said first client location;
(c) communicating said second voice signature to said web server;
(d) retrieving said first voice signature from said central repository;
(e) comparing said first voice signature to said second voice signature to produce a third result; and
(f) adding a second flag configured for indicating said third result to said encounter record,
wherein said first client location is the residence of said client and the eligibility of said healthcare worker to receive payment associated with a time period after step (e) of said visit based on the presence of said healthcare worker at said first client location as determined by said second flag is processed.

7. The method of claim 1, further comprising the steps of:
(a) activating a first request at said proxy mobile device for a response from said healthcare worker;
(b) starting a first timer for a response time period within which said response is expected to be received;
(c) receiving and transmitting said response from said healthcare worker to said web server;
(d) comparing said response to said first request to produce a fourth result; and
(e) adding a third flag for indicating said fourth result to said encounter record, wherein if said first timer of said response time period expires before said response is received or if said response does not match said first request, said healthcare worker becomes ineligible to receive payment associated with said time period after step (d) of said visit.

8. The method of claim 7, wherein said first request is an indicator selected from the group consisting of an audible tone, flashing light and vibrating device.

9. The method of claim 1, further comprising the steps of:
(a) activating a second request at the cell phone for a response from said healthcare worker;
(b) starting a first timer for a response time period within which said response is expected to be received;
(c) receiving and transmitting said response from said healthcare worker to said web server;
(d) comparing said response to said second request to produce a fourth result; and
(e) adding a third flag for indicating said fourth result to said encounter record, wherein if said first timer of said response time period expires before said response is received or if said response does not match said second request, said healthcare worker becomes ineligible to receive payment associated with said time period after step (d) of said visit.

10. The method of claim 9, wherein said second request is a visual instruction to direct said healthcare worker to produce a response commensurate to said visual instruction.

11. The method of claim 1, further comprising the step of:
monitoring for a deviation of a condition from an expected state, wherein said condition is selected from the group consisting of functional connection of any one of a group of devices assigned to said healthcare worker for performing step (b), case integrity of any one of said group of devices assigned to said healthcare worker for performing step (b), use of a genuine fingerprint by said healthcare worker, lack of impact detection of an accelerometer in any one of said group of devices assigned to said healthcare worker for performing step (b) and battery power level of any one of said group of devices assigned to said healthcare worker for performing step (b).

12. The method of claim 1, wherein said client has moved to a second client location, said method further comprises the steps of:
(a) capturing and storing, in said central repository, a third biometric signature of said client during a second enrollment period;
(b) activating a request for a fourth biometric signature from said client during said visit of said healthcare worker;
(c) starting a second timer for a response time period within which said fourth biometric signature is expected to be received;
(d) capturing and receiving, in said proxy mobile device, a fourth biometric signature received of said client and a third geographical location associated with said device from which said fourth biometric signature was captured and received;
(e) capturing and storing, in said proxy mobile device, a fifth biometric signature received of said healthcare worker and a fourth geographical location associated with said device from which said fourth biometric signature was captured and received;
(f) communicating said third biometric signature, said third geographical location, said fourth biometric signature and said fourth geographical location to said web server and storing said third biometric signature, said third geographical location, said fourth biometric signature and said fourth geographical location in said central repository;
(g) retrieving said third biometric signature from said central repository;
(h) comparing said fourth biometric signature to said third biometric signature to produce a fourth result, comparing said fifth biometric signature to said first biometric signature to produce a fifth result, comparing said fourth geographical location to said third geographical location to produce a sixth result; and
(i) adding a fourth flag to indicate said fourth result, adding a fifth flag to indicate said fifth result and adding a sixth flag to indicate said sixth result,
wherein said second client location is a location away from the residence of said client and if at least one of said fourth, fifth and sixth flags indicates a mismatch, said healthcare worker becomes ineligible to receive payment associated with a time period after step (h) of said visit.

13. A system for preventing healthcare fraud, wherein a healthcare worker is employed by an agency to provide healthcare to a client at a first client location, said system comprising:
(a) at least one central repository capable of storing:
a first biometric signature received from said healthcare worker during an enrollment period; and a first geographical location provided based on said first client location;
(b) at least one proxy mobile device, functionally coupled to a cell phone, configured to:
capture and transmit to the cell phone, during a visit to said first client location, a second biometric signature and a second geographical location; and
(c) at least one web server, functionally coupled to said at least one repository, configured to:
receive said second biometric signature and said second geographical location from the cell phone;
retrieve said first biometric signature and said first geographical location from said at least one central repository;
compare said first biometric signature to said second biometric signature and compare said first geographical location to said second geographical location; and
create an encounter record in said at least one central repository, wherein said encounter record comprises a first flag indicating the results of the comparisons made in said at least one web server,
wherein the eligibility of said healthcare worker to receive payment associated with a time period of said visit after said biometric signatures and geographical locations have been compared is based on the presence of said healthcare worker at said first client location as determined by said first flag is processed.

14. The system of claim 13, wherein said first and second biometric signatures are selected from the group consisting of fingerprint scan and iris scan.

15. The system of claim 13, wherein said at least one web server is further configured to:
capture and store, in said at least one central repository, a first voice signature received of said healthcare worker during said enrollment period;
capture and receive, in said at least one proxy mobile device, a second voice signature of said healthcare worker during a visit of said healthcare worker to said first client location;
communicate said second voice signature to said at least one web server;
retrieve said first voice signature from said at least one central repository;
compare said first voice signature to said second voice signature to produce a third result; and
add a second flag for indicating said third result to said encounter record.

16. The system of claim 13, wherein said at least one web server is further configured to:
activate a request for a response from said healthcare worker;
start a first timer for a response time period within which said response is expected to be received;
receive and transmit said response from said healthcare worker to said at least one central repository;
compare said response to said request to produce a fourth result; and
add a third flag for indicating said fourth result to said encounter record.

17. The system of claim 16, wherein said request comprises a visual instruction presented at the cell phone to direct said healthcare worker to produce a response commensurate to said visual instruction.

18. The system of claim 16, wherein said request is an indicator selected from the group consisting of an audible tone, flashing light and vibrating device.

19. The system of claim 13, wherein said at least one web server is further configured to:
monitor for a deviation of a condition from an expected state, wherein said condition is selected from the group consisting of functional connection of any one of a group of devices assigned to said healthcare worker for responding to said agency, case integrity of any one of said group of devices assigned to said healthcare worker for responding to said agency, use of a genuine fingerprint by said healthcare worker, lack of impact detection of an accelerometer in any one of said group of devices assigned to said healthcare worker for responding to said agency and battery power level of any one of said group of devices assigned to said healthcare worker for responding to said agency.

20. The system of claim 13, wherein said at least one web server is further configured to:
capture and store, in said at least one central repository, a third biometric signature of said client during a second enrollment period;
activate a request at said at least one proxy mobile device for a fourth biometric signature from said client during said visit of said healthcare worker;
start a second timer for a response time period within which said fourth biometric signature is expected to be received;
capture and store, in said at least one central repository, said fourth biometric signature received of said client and a third geographical location associated with said device from which said fourth biometric signature was captured and received;
capture and store, in a central repository, a fifth biometric signature received of said healthcare worker and a fourth geographical location associated with said device from which said fourth biometric signature was captured and received;
retrieve said third biometric signature from said central repository;
compare said fourth biometric signature to said third biometric signature to produce a fourth result, compare said fifth biometric signature to said first biometric signature to produce a fifth result, compare said fourth geographical location to said third geographical location to produce a sixth result; and
add a fourth flag to indicate said fourth result, add a fifth flag to indicate said fifth result and add a sixth flag to indicate said sixth result.
